(19) United States
(12) Patent Application Publication
(10) Pub. No.: US 2026/0154565 A1
(43) Pub. Date: Jun. 4, 2026

(54) METHODS FOR DETERMINING UPLINK SCALING FACTOR IN OVER-THE-AIR FEDERATED LEARNING TRAINING ROUNDS

(71) Applicant: InterDigital Patent Holdings, Inc., Wilmington, DE (US)

(72) Inventors: Asil Koc, Verdun (CA); Philip Pietraski, Jericho, NY (US); Guodong Zhang, Woodbury, NY (US); Mohamed Amine Arfaoui, Montreal (CA); John Kaewell, Jamison, PA (US)

(73) Assignee: InterDigital Patent Holdings, Inc., Wilmington, DE (US)

(21) Appl. No.: 18/965,187

(22) Filed: Dec. 2, 2024

(51) Int. Cl. G06N 3/098; H04W 72/21

(52) U.S. Cl. CPC G06N 3/098; H04W 72/21

(57) ABSTRACT

A WTRU may receive over the air federated learning (OTA-FL) configuration information associated with a local AI/ML model at the WTRU. The WTRU may send feedback information. The WTRU may receive from the network model parameter reporting configuration. The model parameter reporting configuration may include an uplink scaling factor. The WTRU may determine one or more uplink pre-equalization factors for one or more resource elements associated with one or more model parameters associated with the local AI/ML model based on, for example, the uplink scaling factor. The WTRU may send to the network the one or more pre-equalized model parameters using the one or more associated resource elements of the local AI/ML model.

### BACKGROUND

AI may be broadly referred to as the behavior exhibited by machines that mimic cognitive functions to sense, reason, adapt, and/or act. An AI component may refer to the realization of behaviors and/or conformance to requirements by learning based on data, without explicit configuration of sequence of procedures of actions.

### SUMMARY

In over-the-air (OTA) federated learning (FL), when a wireless transmit/receive unit (WTRU) is configured to pre-equalize the transmission of locally updated artificial intelligence (AI)/machine learning (ML) model parameters, the pre-equalization may target improving the quality of OTA aggregation (e.g., through preventing pathloss biased OTA aggregation and/or enabling weighted OTA aggregation). The pre-equalization may include determining and/or configuring an uplink scaling factor for each WTRU participating to the OTA-FL training rounds. For example, an optimal uplink scaling factor may be based on one or more (e.g., various) parameters including the local training data information, the locally updated AI/ML model performance, the channel estimate statistic(s), etc. Described herein are WTRU procedure(s) to support determining the uplink scaling factor in OTA-FL training rounds.

A WTRU may receive (e.g., via a transceiver) OTA-FL configuration information associated with a local AI/ML model at the WTRU. The WTRU may send (e.g., via the transceiver, to a network) feedback information. The feedback information may include local training data information, an indication of the performance of the local AI/ML model, one or more channel estimates, and/or one or more transmit power related metrics. The WTRU may receive (e.g., via the transceiver) from the network model parameter reporting configuration. The model parameter reporting configuration may include an uplink scaling factor. The WTRU may determine one or more uplink pre-equalization factors for one or more resource elements associated with one or more model parameters associated with the local AI/ML model based on, for example, the uplink scaling factor. The WTRU may send (e.g., via the transceiver) to the network the one or more pre-equalized model parameters using the one or more associated resource elements of the local AI/ML model.

The WTRU may send a calibration transmission to the network. The WTRU may receive a calibration response message from the network. The WTRU may determine the uplink pre-equalization factors based on the calibration response message.

The configuration information may include one or more allocations of uplink resources for one or more OTA-FL training rounds. The WTRU may use the one or more allocations of uplink resources to send the one or more pre-equalized model parameters. A plurality of WTRUs may include the WTRU. The WTRU may send the one or more pre-equalized model parameters using the same one or more allocations of uplink resources as allocated to at least one other WTRU (e.g., that is/are performing the same and/or a similar OTA-FL training task(s)) of the plurality of WTRU.

The WTRU may apply one or more of a phase correction, a channel inversion, and/or a truncated channel inversion based on the determined one or more uplink pre-equalization factors. The WTRU being configured to determine the one or more uplink pre-equalization factors may include the WTRU being configured to use the uplink scaling factor to compensate for one or more of the phase correction, the channel inversion, and/or the truncated channel inversion.

The one or more channel estimates may include one or more of a maximum channel power, a minimum channel power, a mean channel power, and/or a pathloss. The one or more transmit power related metrics may include a WTRU transmit power headroom report (PHR) for OTA-FL transmission.

The one or more pre-equalized model parameters may include one or more of: one or more weights and/or biases associated with the local AI/ML model; one or more AI/ML model parameter incremental updates based on a difference between one or more parameters of the local AI/ML model and one or more parameters of a second AI/ML model sent from the network; and/or a gradient of a loss function associated with the one or more parameters of the local AI/ML model.

The WTRU may receive training related information. The training related information may include one or more of a loss function, an epoch, a learning rate, and/or a set of thresholds to monitor training progress of the local AI/ML model. The WTRU may determine the one or more uplink pre-equalization factors based on the received training related information.

The WTRU may send an indication to the network. The indication may indicate one or more capabilities of the WTRU to participate in one or more OTA-FL training rounds. The WTRU may receive the OTA-FL configuration information in response to the indication.

The WTRU may update the local AI/ML model in each training round of a plurality of OTA-FL training rounds based on the determined one or more uplink pre-equalization factors.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example federated learning (FL) over the (e.g., 5G) system.

FIG. 3 depicts an example (e.g., typical) FL protocol over wireless communication systems.

FIG. 4 depicts an example illustration of the (e.g., conventional) FL and/or over-the-air (OTA)-FL in wireless communication systems.

FIG. 5 depicts an example illustration of the procedures for OTA-FL in wireless communication systems.

FIG. 6 depicts an example of mapping the locally updated (e.g., trained) artificial intelligence (AI)/machine learning (ML) model parameters to the uplink resources during OTA-FL transmissions.

FIG. 7 depicts an example flowchart of WTRU procedures for determining an uplink scaling factor in OTA-FL training rounds.

FIG. 8 depicts an example of ResNet-8 model for AI/ML-based image classification.

FIG. 9 depicts an image classification test accuracy during OTA-FL training rounds for Scenario #1.

FIG. 10 depicts an image classification test accuracy during OTA-FL training rounds for Scenario #2.

FIG. 11 depicts an image classification test accuracy during OTA-FL training rounds for Scenario #3.

### DETAILED DESCRIPTION

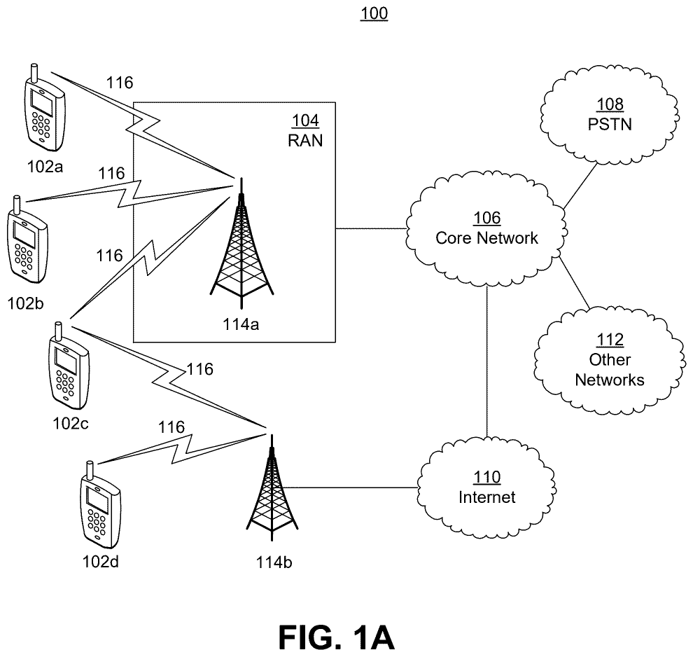

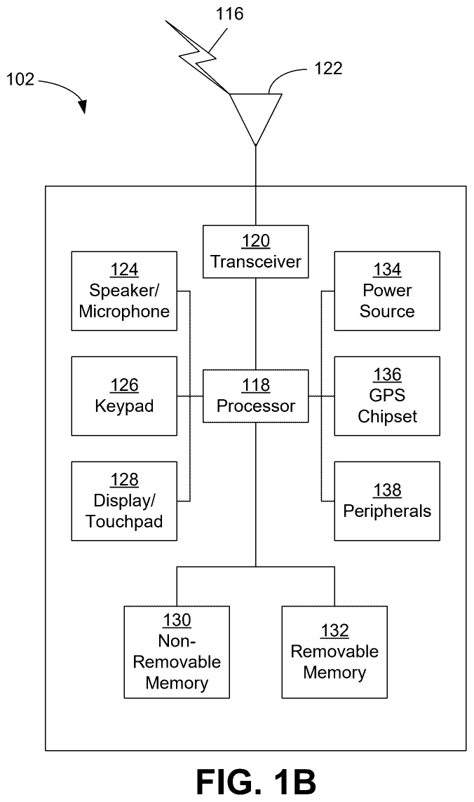

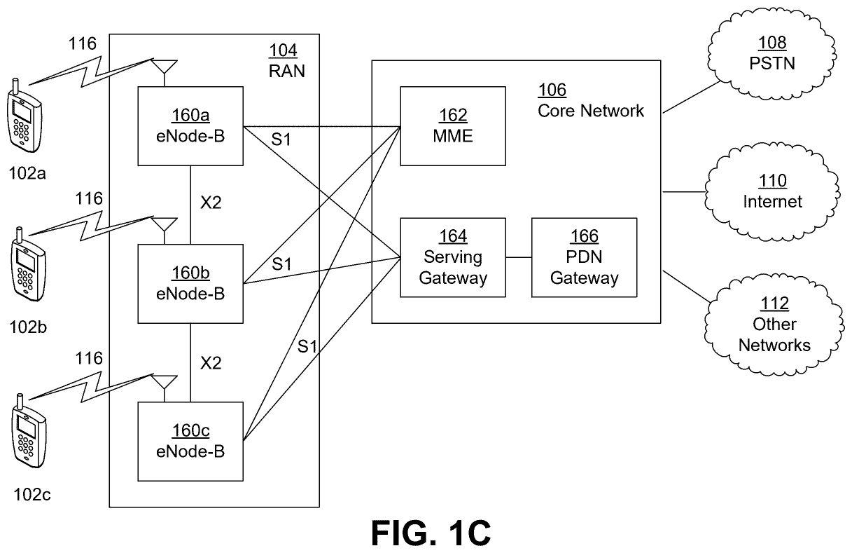

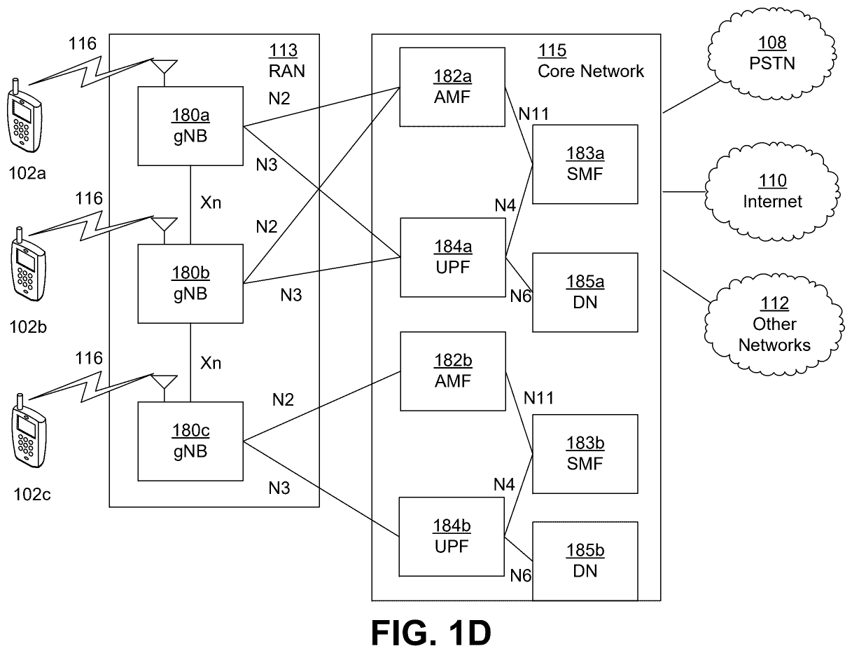

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Over-the-air federated learning (OTA-FL) may include one or more challenges in addition to the ones inherited from (e.g., conventional) FL. The analog OTA signal aggregation in wireless channels may be subject to distortion(s) caused by channel fading, path loss, radio impairment, and/or receiver noise. For example, consider a first WTRU that is experiencing higher path loss compared to a second WTRU. When the two WTRUs participate to the OTA-FL training rounds with the same transmit power, it may lead to a pathloss biased OTA aggregation. On the other hand, a completely unbiased OTA aggregation, where one or more (e.g., all) WTRUs' AI/ML model parameters are received with the same scale at the network (NW), can also lead to the AI/ML model performance degradation since the update(s) from one or more WTRUs may carry different importance. There may be no mechanism for preventing pathloss biased OTA aggregation and/or enabling weighted OTA aggregation through setting an uplink scaling factor for each WTRU.

In over-the-air (OTA) federated learning (FL), when a wireless transmit/receive unit (WTRU) is configured to pre-equalize the transmission of locally updated artificial intelligence (AI)/machine learning (ML) model parameters, the pre-equalization may target improving the quality of OTA aggregation (e.g., through preventing pathloss biased OTA aggregation and/or enabling weighted OTA aggregation). The pre-equalization may include determining and/or configuring an uplink scaling factor for each WTRU participating to the OTA-FL training rounds. For example, an optimal uplink scaling factor may be based on one or more (e.g., various) parameters including the local training data information, the locally updated AI/ML model performance, the channel estimate statistic(s), etc. Described herein are WTRU procedure(s) to support determining the uplink scaling factor in OTA-FL training rounds.

For systems using the distributed learning to collaboratively learn a task and/or a function, embodiments described herein may include methods for determining an uplink scaling factor in OTA-FL training rounds.

AI may be broadly referred to as the behavior exhibited by machines that mimic cognitive functions to sense, reason, adapt, and/or act. An AI component may refer to the realization of behaviors and/or conformance to requirements by learning based on data, without explicit configuration of sequence of procedures of actions. Such AI component(s) may enable learning complex behaviors which might be difficult to specify and/or implement when using other (e.g., legacy) methods.

Machine learning (ML) may refer to the type of algorithm(s) that solve a problem based on learning through experience (e.g., data), without being explicitly programmed (e.g., configuring a set of rules). ML can be considered as a subset of AI. Different ML paradigms may be envisioned based on the nature of data and/or feedback available to the learning algorithm. In examples, a supervised learning approach may include learning a function that maps input to an output based on labeled training example, where each training example may be a pair including an input and its corresponding output. In examples, an unsupervised learning approach may include detecting patterns in the data with no pre-existing labels. In examples, a reinforcement learning approach may include performing sequence of actions in an environment to maximize the cumulative reward. In examples, it may be possible to apply ML algorithms using a combination and/or interpolation of the above-mentioned approaches. For example, a semi-supervised learning approach may use a combination of a small amount of labeled data with a large amount of unlabeled data during training. Semi-supervised learning may fall between unsupervised learning (e.g., with no labeled training data) and supervised learning (e.g., with only labeled training data).

Deep learning may refer to a class of ML algorithms that employ artificial neural networks, specifically, Deep Neural Networks (DNNs), which were loosely inspired from biological systems. The DNNs may be a special class of ML models that are inspired by the human brain, where the input may be linearly transformed and/or may pass through non-linear activation function one or more (e.g., multiple) times. DNNs may include one or more (e.g., multiple) layers, where each layer may include linear transformation and/or a given non-linear activation function. The DNNs can be trained using the training data via back-propagation algorithm. DNNs may show state-of-the-art performance in one or more (e.g., a variety of) domains (e.g., speech, vision, natural language, wireless communication, etc.), and/or for one or more (e.g., various) ML settings (e.g., supervised, un-supervised, semi-supervised, etc.).

The applications of AI/ML in wireless communications can improve the performance of communication systems, while wireless communications can be also utilized to improve the AI/ML model performance.

As a distributed machine learning technique, federated learning (FL) may improve the AI/ML model performance towards a stronger model generalization via collaborative learning across decentralized dataset, while preserving the data privacy and/or eliminating the (e.g., large) overhead of dataset sharing. In FL, the central AI server may obtain a global model by combining (e.g., aggregating) local models trained by each participant (e.g. WTRU) based on a model averaging technique. Unlike the (e.g., conventional) centralized learning, FL may preserve the data privacy by removing the need of dataset transfer from the participants (e.g., WTRUs) to the central AI server (e.g., NW) during the AI/ML model training. FL may (e.g., greatly) reduce the communication overhead through eliminating one or more (e.g., large) dataset transfers. The AI/ML models trained through FL may achieve a stronger model generalization compared to the locally trained AI/ML models since, for example, FL enables AI/ML models to learn from datasets from one or more conditions and/or distributions.

A WTRU may perform its local model training within each training cycle based on a model downloaded from the centralized AI server using local data. Once the local model training is completed, for example, the WTRU may deliver the training results (e.g., gradient for the Deep Neural Network-DNN) to the centralized AI server via one or more uplink (UL) channels. The centralized AI server may aggregate the gradients (e.g., model parameters) from the WTRUs, and/or may update the global model. The next training cycle may begin where the AI server distributes the updated global model to WTRUs through one or more downlink (DL) channels.

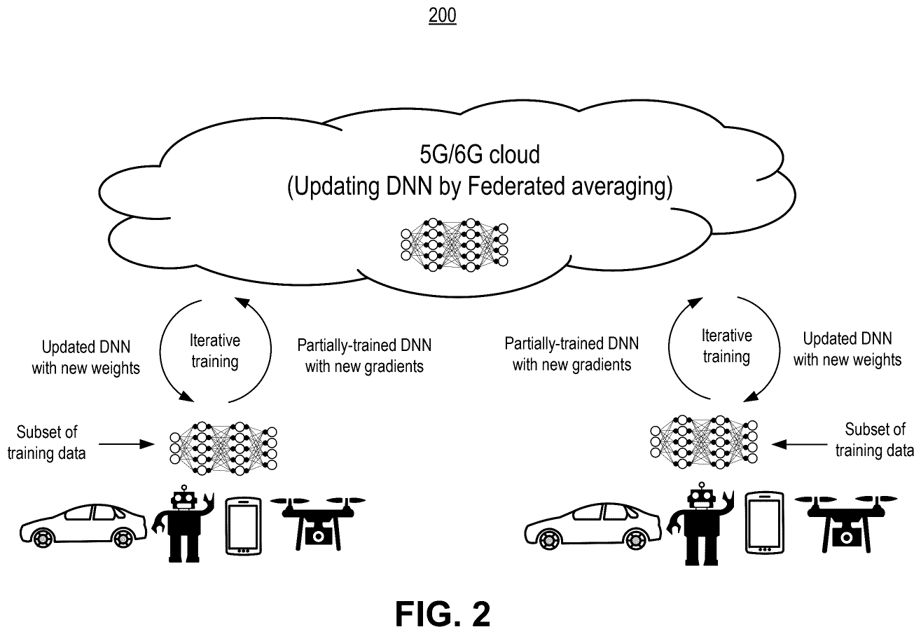

FIG. 2 depicts an example of a high-level interaction between participants (e.g., WTRUs) and the central AI server over a (e.g., 5G) system 200.

The FL training over wireless communication is slightly different than the FL training in data centers, where participants (e.g., WTRUs) may have (e.g., highly) variable conditions in terms of available computational and/or network resources. Additionally or alternatively, the WTRUs may not be homogeneous, so they may have different capabilities in terms of their computing and/or network-related resources, and/or even what ML frameworks they support. It may not be efficient for a centralized AI server to include one or more (e.g., all) of the WTRUs (participants) in a training session, so some sort of member selection mechanism may be required before each training cycle begins. If the conditions (e.g., device's computation resource and/or wireless channel condition) did not change, for example, the WTRU re-selection and/or training re-configurations may not be included for each training cycle. Embodiments described herein may include re-selecting one or more different WTRUs over time to achieve global training with diverse decentralized datasets.

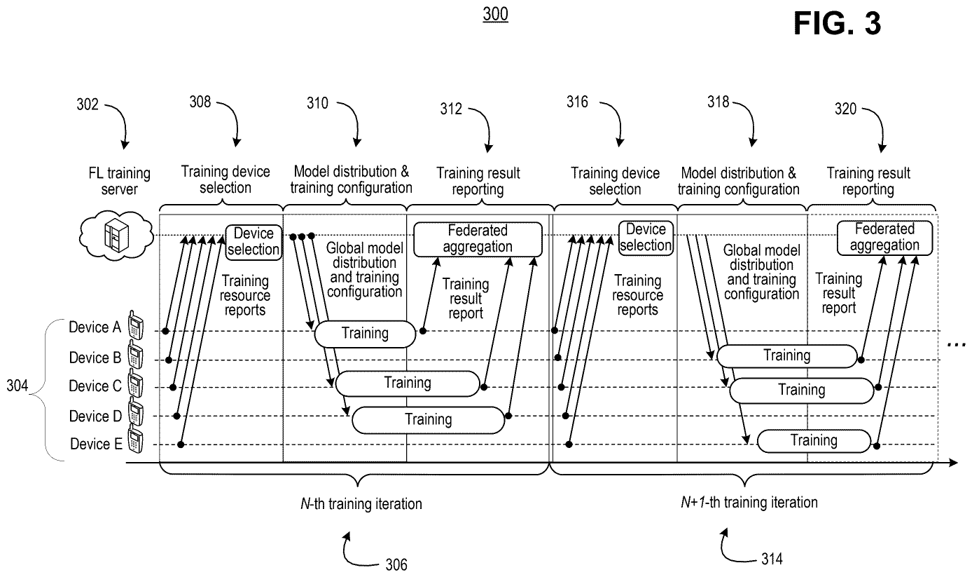

FIG. 3 depicts an example (e.g., typical) FL protocol over wireless communication systems 300. FIG. 3 highlights an example FL scenario where a set of participants (e.g., Devices A-E 304) may be involved in a distributed training session. One or more (e.g., not all) end devices (e.g., WTRUs) may not be involved in each training cycle. In one or more training cycles, one or more WTRUSs may be inactive, while in other sessions, they may be busy training a local model. For example, Device A may be initially (e.g., during the Nth cycle 306) engaged in a training session; after it reports its training resources, the centralized FL server 302 may not select Device A for the next cycle (e.g., (N+1)th cycle 314). Instead, the centralized FL server 302 may select Device B, which may be inactive during the Nth cycle 306.

As depicted in FIG. 3, each FL training cycle can be categorized into one or more (e.g., three) operating stages. In a first operating stage (at 308, at 316), the FL server 302 may select a set of training devices (e.g., WTRUs 403). During this stage, the training devices (e.g., 304) may express their training resources to the FL server 302. Once the FL server 304 collects (e.g., all) the information from the one or more training devices, it can select one or more (e.g., some) of them, and/or it may enter a second operating stage (e.g., model distribution and/or training configuration; at 310, at 318), where the FL server 302 may distribute a global trained model and/or related configuration(s) to one or more (e.g., all) selected devices (e.g., WTRUs 304). Upon the other model's arrival and configuration, the WTRUs (e.g., 304) may start local model training (e.g., at a different point in time). Once the local training is completed at a WTRU (e.g., 304), for example, local AI/ML model parameters are delivered to the FL server, where a third operating stage may begin (e.g., at 312, at 320). During this stage, the FL server may aggregate one or more (e.g., all) training results to form a global model and/or may repeat the (e.g., whole) training workflow (e.g., again).

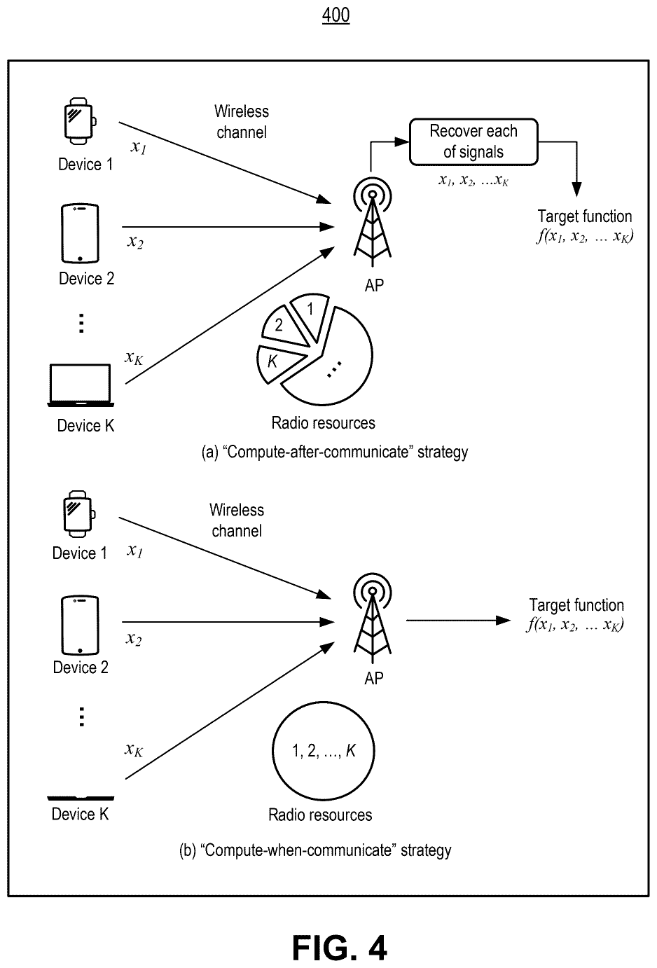

FIG. 4 depicts an example illustration of the (e.g., conventional) FL and/or over-the-air (OTA)-FL in wireless communication systems 400. FL may require a dedicated channel for each participating WTRU, as shown in FIG. 4. End-to-end latency may scale with the number of devices. Over-the-air federated learning (OTA-FL) may enhance the benefit(s) of FL by reducing the end-to-end latency and/or communication overhead through analog aggregation over-the-air. As shown in FIG. 3, each participating WTRU may transmit its locally updated (e.g., trained) AI/ML model parameters (and/or gradients) over interfering radio resources (e.g., channels) during the OTA-FL training rounds. The locally updated AI/ML model parameter(s) may be aggregated and/or combined over-the-air. The NW may receive the aggregated AI/ML model parameters (and/or gradients).

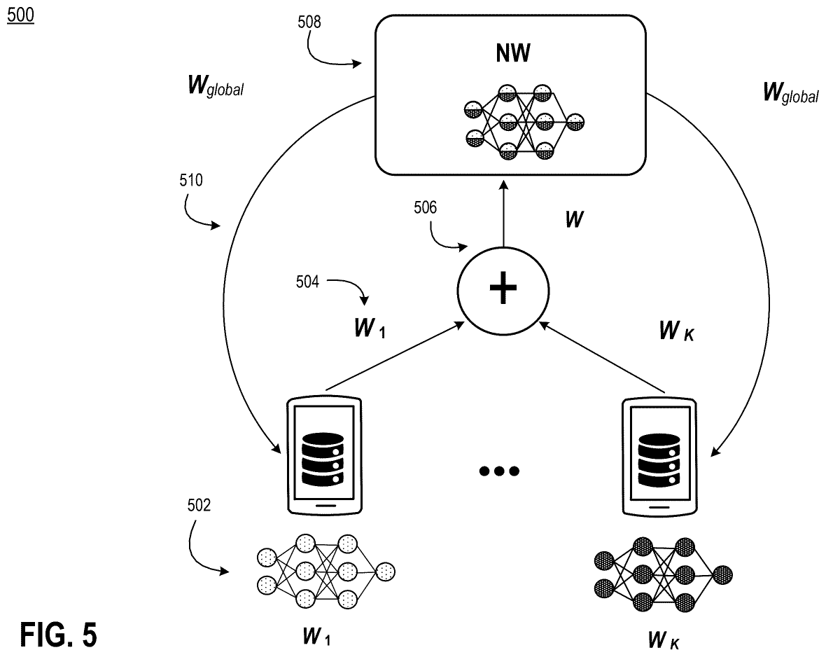

FIG. 5 depicts an example illustration of the procedures for OTA-FL in wireless communication systems 500. FIG. 5 depicts one or more (e.g., five) procedures for OTA-FL in wireless communication systems.

A first procedure (e.g., at 502) for OTA-FL in wireless communication systems may include local training. For example, the WTRU may perform the local AI/ML training through its own dataset.

A second procedure (e.g., at 504) for OTA-FL in wireless communication systems may include pre-processing. The WTRU may perform (e.g., some) pre-processing to the locally updated (e.g., trained) AI/ML model parameter(s) before transmitting them (e.g., computing the gradients, calculating the difference between the locally updated AI/ML model parameter(s) and the received global AI/ML model parameter(s) in the previous OTA-FL training round, etc.).

A third procedure (e.g., at 506) for OTA-FL in wireless communication systems may include OTA aggregation. The WTRU may transmit the locally updated AI/ML model parameter(s) (and/or gradient), where one or more (e.g., all) participating WTRUs may use the same radio resources (e.g., physical channel). The NW may receive the aggregated AI/ML model parameter(s) (and/or gradients). For example, at the example, at the t^{th} OTA-FL training round, the received signal at the NW can be written as follows:

$${y}^{( t )} = {\sum }_{k = 1}^{K} {h}_{k}^{( t )} {w}_{k}^{( t )} + {n}^{( t )} , \qquad ( Equation 1 )$$

where K may be the total number of WTRUs participating in the OTA-FL training rounds,

$${h}_{k}^{( t )}$$

may be the channel between the NW and the k^{th} WTRU (e.g., with single-antenna at the NW and each WTRU) during the t^{th} OTA-FL training round,

$${w}_{k}^{( t )}$$

may be the (e.g., pre-processed) locally updated AI/ML model parameters (and/or gradient) at the k^{th} WTRU, and n^{(t)} may be the receiver noise at the NW in the t^{th} OTA-FL training round. The term y^{(t)} may represent the OTA aggregated AI/ML model parameters (and/or gradient).

A fourth procedure (e.g., at 508) for OTA-FL in wireless communication systems may include post-processing. The NW may apply (e.g., some) post-processing to obtain a (e.g., new) global AI/ML model. In examples, the post-processing may include developing another (e.g., new) global AI/ML model using the received aggregated gradients and/or the global AI/ML model from the previous OTA-FL training round. In example, the post-processing may be performed through a function φ(.) as:

$${\tilde{y}}^{( t )} = φ ( {y}^{( t )} ) \approx {\sum }_{k = 1}^{K} {w}_{k}^{( t )} . \qquad ( Equation 2 )$$

A fifth procedure (e.g., at 510) for OTA-FL in wireless communication systems may include a global model delivery. The NW may distribute the updated global AI/ML model to one or more WTRUs.

Over-the-air federated learning (OTA-FL) may include one or more challenges in addition to the ones inherited from (e.g., conventional) FL. The analog OTA signal aggregation in wireless channels may be subject to distortion(s) caused by channel fading, path loss, radio impairment, and/or receiver noise, which may negatively affect the OTA aggregation quality. For example, consider a first WTRU that is experiencing higher path loss compared to a second WTRU. When the two WTRUs participate to the OTA-FL training rounds with the same transmit power, the received AI/ML model at the NW may become more biased towards the local AI/ML model of the second WTRU, for example, since its signals may have higher amplitude (e.g., 10 times higher amplitude) in OTA aggregation. This pathloss biased OTA aggregation can lead to the AI/ML model performance degradation. A completely unbiased OTA aggregation, where one or more (e.g., all) WTRUs' AI/ML model parameters are received with the same scale at the network (NW), can lead to the AI/ML model performance degradation since the update(s) from one or more WTRUs may carry different importance, diversity, and/or signal quality, and/or may be biased and/or weighted to account for it. The WTRUs may have different size, quality, diversity of data, and/or experience different channel conditions, etc. There may be no mechanism for preventing pathloss biased OTA aggregation and/or enabling weighted OTA aggregation through setting an uplink scaling factor for each WTRU.

A WTRU may be configured to determine an uplink scaling factor in OTA-FL training rounds. In OTA-FL, each participating WTRU may locally train an AI/ML model for the same (and/or similar) task. When a WTRU is configured to pre-equalize the transmission of (partially) trained local AI/ML model parameter(s), the pre-equalization may target improving the quality of OTA aggregation, for example, through preventing pathloss biased OTA aggregation and/or enabling weighted OTA aggregation. The pre-equalization may target mitigating the effect of wireless channels. The pre-equalization performance may be based on uplink channel estimation accuracy. The pre-equalization may require determining and/or configuring an uplink scaling factor for each WTRU participating to the OTA-FL training rounds. For example, by using the first equation, as described herein, the received OTA aggregated signal at the NW can be written as follows:

$${y}^{( t )} = {\sum }_{k = 1}^{K} {h}_{k}^{( t )} {p}_{k}^{( t )} {w}_{k}^{( t )} + {n}^{( t )} \approx {\sum }_{k = 1}^{K} {α}_{k} {w}_{k}^{( t )} , \qquad ( Equation 3 )$$

where K may be the total number of WTRUs participating in the OTA-FL training rounds,

$${h}_{k}^{( t )}$$

may be the uplink channel between the NW and the k^{th} WTRU (with single-antenna at the NW and each UE),

$${w}_{k}^{( t )}$$

may be the pre-equalization scalar at the k^{th} WTRU,

$${p}_{k}^{( t )}$$

may be the locally updated AI/ML model parameter(s) at the k^{th} WTRU, αₖ may denote a scalar related to the uplink scaling factor at the k^{th} WTRU, and n^{(t)} may be the receiver noise at the NW. Equation (3) may show that the uplink scaling factor enables weighted OTA aggregation.

An (e.g., optimal) uplink scaling factor may be based on one or more (e.g., various) parameters including the local data information (e.g., size, quality, and/or diversity of local data), the locally updated (e.g., trained) AI/ML model performance, the channel estimate statistic(s) (e.g., maximum/minimum/mean channel power, pathloss, etc.), and/or the like. Embodiments described herein may include WTRU procedures to support determining the uplink scaling factor in OTA-FL training rounds. Embodiments herein may be applicable for time division duplexing (TDD) and/or frequency division duplexing (FDD) wireless communication systems.

A WTRU may be configured to support determining an uplink scaling factor in OTA-FL training rounds. A WTRU may receive a (e.g., pre-trained) first AI/ML model and/or a portion of the first AI/ML model, for example, form a network. The pre-trained (e.g., global) first AI/ML model may be a common neural network architecture to perform the same (and/or similar) function. For example, a WTRU may receive (e.g., via a transceiver), OTA-FL configuration information associated with a local AI/ML model at the WTRU. The OTA-FL configuration information may include one or more allocations of uplink resources for one or more OTA-FL training rounds. A WTRU may send an indication to the network. The indication may indicate one or more capabilities of the WTRU to participate in one or more OTA-FL training rounds. The WTRU may receive the OTA-FL configuration information in response to the indication.

A WTRU may send (e.g., through uplink control information (UCI) and/or medium access control (MAC) control element (CE) an AI/ML model update feedback message to the NW. The AI/ML model update feedback message may include one or more of the following. The AI/ML model update feedback message may include a sum (and/or mean) of difference between the received pre-trained first AI/ML model parameter(s) and a second local AI/ML model parameter(s). For example, the second local AI/ML model may be an AI/ML model trained previously (e.g., in a previous OTA-FL training round). The AI/ML model update feedback message may include the performance improvement with the received pre-trained first AI/ML model (e.g., the test performance difference between the received pre-trained first AI/ML model parameter(s) and a second local AI/ML model parameters). For example, the WTRU may send (e.g., via the transceiver) feedback information to a network. The feedback information may include one or more of local training data information, an indication of the performance of the local AI/ML model, one or more channel estimates, and/or one or more transmit power related metrics.

The WTRU may report local AI/ML model training data information (e.g., size, quality, diversity, etc.) to the NW.

The WTRU may receive a training data configuration message. The training data configuration may include information with respect to how to select the training data to train a third (e.g., local) AI/ML model. For example, in a classification problem, the WTRU may locally train the entire (or part of) AI/ML model by using (e.g., only) the selected data classes, which may be configured through the data configuration message. The NW may select the corresponding data classes, which the AI/ML model may achieve poor performance. For example, the network may select the parts of the AI/ML model to be updated by the WTRU. Such selection may be based on performance of those parts below a threshold. Triggers for such event may include one or more of: fine-tuning the AI/ML model caused by model drift; one or more other candidate layers; and/or fine-tuning for a similar task (e.g., transfer learning, etc.).

The WTRU may send a calibration transmission (e.g., sounding reference signal (SRS)) to the network, for example, after receiving one or more downlink reference signals (e.g., phase tracking reference signal (PT-RS), channel state information reference signal (CSI-RS), etc.). The calibration transmission may include a multi-symbol response in the symbols, which may be (e.g., later) utilized for the uplink transmission(s) in the OTA-FL training rounds. The calibration transmission may be periodic, semi-persistent, aperiodic.

The WTRU may receive a calibration message from the network, for example, to correct the UL/DL phase error and/or amplitude error. The calibration message may indicate how the WTRU adjusts the phase and/or amplitude (e.g., per resource element (RE)). The calibration message may include one or more parameters for enabling a WTRU to perform the prediction(s) on the channel aging and/or the predictions for pre-equalization. The calibration message may indicate which set of REs are qualified for the UL transmission in OTA-FL training rounds (e.g., first two OFDM symbols after CSI-RS are qualified, while next OFDM symbols are disqualified).

The WTRU and/or a WTRU group may be configured to participate in one or more OTA-FL training round(s). The WTRU may receive a request and/or an indication to participate in one or more OTA-FL training rounds for updating the model parameter(s) of the received pre-trained first AI/ML model and/or the locally trained second AI/ML model. The WTRU may receive an indication to identify which portion(s) of the AI/ML model may be trained and/or updated through OTA-FL training round(s) (e.g., only last few layers may be trained). The WTRU may receive configuration to send one or more of the following parameters. The WTRU may receive configuration to send the locally updated third AI/ML model parameter(s) for the AI/ML model being locally trained (e.g., weights and/or biases). The WTRU may receive configuration to send the AI/ML model parameter incremental update(s) (e.g., the difference between the parameters of the locally updated third AI/ML model and a reference AI/ML model). The reference AI/ML model may be a most recently received AI/ML model from the NW (e.g., as result of aggregation, and/or the initial AI/ML model configured by the NW). The WTRU may receive configuration to send the gradient (and/or a set of gradients, and/or a function of the gradient(s)) of the loss function with respect to the AI/ML model parameter(s) measured by the WTRU during local training and/or loss computation(s). In examples, the optimizer function may be in the NW. The WTRU may receive uplink resource allocation(s) for OTA-FL training round(s), which may be common for one or more (e.g., all) WTRUs participating in the same one or more OTA-FL training round(s). For example, the one or more WTRUs participating in the same one or more OTA-FL training round(s) may use one or more of the same UL resources to transmit the locally updated third AI/ML model parameter(s) and/or the gradient(s) and/or the AI/ML model parameter incremental update(s). The one or more pre-equalized model parameters may include one or more of: one or more weights and/or biases associated with the local AI/ML model; one or more AI/ML model parameter incremental updates based on a difference between one or more parameters of the local AI/ML model and one or more parameters of a second AI/ML model sent from the network; and/or a gradient of a loss function associated with the one or more parameters of the local AI/ML model.

The WTRU may receive a configuration about how the locally updated third AI/ML model parameter(s) (and/or the gradients and/or the AI/ML model parameter incremental update(s)) are mapped to UL resources.

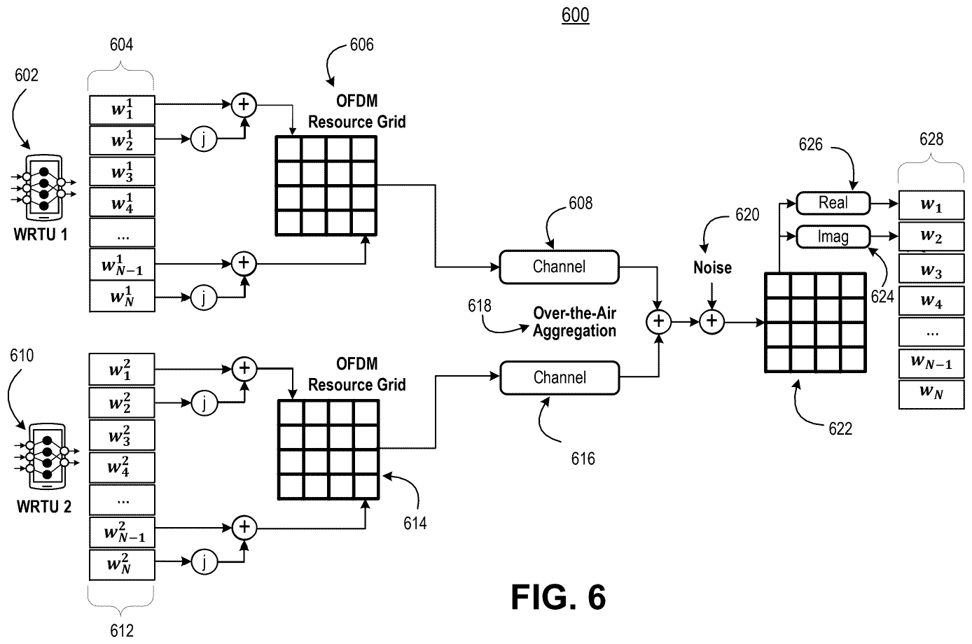

FIG. 6 depicts an example of mapping the locally updated (e.g., trained) artificial intelligence (AI)/machine learning (ML) model parameters to the uplink resources during OTA-FL transmissions 600. Specifically, FIG. 6 presents an example of two WTRUs, which are WTRU 1 602 and WTRU 610, mapping their respective AI/ML model parameters to uplink resources during OTA FL transmission. WTRU 1 602 and WTRU 2 610 may each have a set of N real-valued AI/ML parameters in 604 and 612, respectively, transmitted without (e.g., any) encoding and/or digital modulation to achieve over-the-air aggregation. For WTRU 1 602 and WTRU 2 610, each of two AI/ML model parameters may be combined as the real-part and imaginary-part of a complex symbol, and/or the corresponding complex symbol may be mapped to an uplink RE as shown in 606 and 614, respectively, following configuration from the NW. In examples, N/2 uplink REs may be required to accommodate the transmission of N real-valued AI/ML parameter(s) in the OTA-FL manner. In examples, each real-valued AI/ML model parameter may be mapped to β∈ [symbol] ⁺ uplink REs to enhance the OTA aggregation accuracy (e.g., for β=2, an AI/ML model parameter may be mapped to two uplink REs). The sign of symbols in uplink REs may be alternated to (e.g., further) reduce the phase errors (e.g., for β=2, an AI/ML model parameter may be multiplied with +1 and/or −1 to create symbols to be mapped into two uplink REs). In examples, βN uplink REs may be required to accommodate the transmission of N real-valued AI/ML parameters in the OTA-FL manner. WTRU 1 602 and/or WTRU 2 610 may transmit their respective mapped AI/ML model parameters to the NW (e.g., at 608, at 616), to be aggregated over-the-air at 618. At the NW side, the aggregated AI/ML model parameters may experience noise 620 at the NW's receiver. The NW may extract the complex symbol from each UL RE at 622, may extract the imaginary part at 624, and/or the real part at 626 from the extracted complex symbol from each UL RE, and/or may recover the N aggregated AI/ML model parameters at 628.

To participate in the one or more OTA-FL training rounds, the WTRU may receive a configuration for what type of uplink pre-equalization (e.g., phase correction, channel inversion, truncated channel inversion) may be included. The WTRU may apply one or more of a phase correction, a channel inversion, and/or a truncated channel inversion based on the one or more uplink pre-equalization factors. The WTRU being configured to determine the one or more uplink pre-equalization factors may include the WTRU being configured to use the uplink scaling factor to compensate for one or more of the phase correction, the channel inversion, and/or the truncated channel inversion.

To participate in the one or more OTA-FL training rounds, the WTRU may receive training related information (e.g., loss function, epoch, learning rate, a set of thresholds to monitor the training progress, etc.). For example, the WTRU may receive training related information; the training related information may include one or more of a loss function, an epoch, a learning rate, and/or a set of thresholds to monitor training progress of the local AI/ML model.

The WTRU may determine the locally updated third AI/ML model (e.g., through local AI/ML model training), for example, based on the received training data configuration message. The WTRU may train the (e.g., entire, portion of) AI/ML model based on the received configuration. The WTRU may perform fine-tuning to the received pre-trained first AI/ML model. The WTRU may send a message indicating that the locally updated second AI/ML model has been (e.g., sufficiently) trained to the NW, for example, when the WTRU detects that the training is sufficient through evaluating the performance of the locally updated second AI/ML model based on the configured thresholds for performance monitoring. One or more factors and/or training-stop rules may be included to determine whether training is sufficient. For example, the WTRU can determine sufficient training in FL by monitoring local model performance, resource constraint(s), gradient update(s), and/or feedback from the FL server on global model convergence, etc.

The WTRU may report the training statistic(s) to the NW, for example, based on the received OTA-FL configuration. The training statistic(s) may include one or more of the locally updated third AI/ML model parameter information (e.g., maximum, minimum, mean, variance of the locally updated AI/ML model parameter(s) and/or the gradient(s) and/or the AI/ML model parameter incremental update, etc.).

The WTRU may perform DL channel estimation, for example, by using received CSI-RS REs.

The WTRU may report channel and/or transmit power related metric(s) to the NW to determine an uplink scaling factor. The reported metric(s) may include one or more of downlink channel estimate statistics (e.g., maximum, minimum, mean, variance of DL channel estimates, the estimated DL channel path loss) and/or the WTRU transmit power headroom report (PHR) for OTA-FL transmission, which may refer to WTRU Max transmission power minus P (OTA-FL). The parameter P (OTA-FL) may be the estimated transmit power of the scheduled OTA-FL transmission in the unweighted manner. For example, the one or more channel estimates may include one or more of a maximum channel power, a minimum channel power, a mean channel power, and/or a pathloss. For example, the one or more transmit power related metrics may include a WTRU transmit power headroom report (PHR) for OTA-FL transmission.

The WTRU may receive an AI/ML reporting configuration, including the uplink scaling factor. For example, the WTRU may receive (e.g., from the network, via the transceiver) model reporting configuration. The model parameter reporting configuration may include an uplink scaling factor.

The WTRU may determine the pre-equalization to the locally updated AI/ML model parameter(s) (and/or the gradients and/or the AI/ML model parameter incremental updates) by using one or more of the estimated DL channels, the received calibration message, received OTA-FL training configuration, and/or the received AI/ML reporting configuration (e.g., UL scaling factor). For example, the WTRU may determine one or more uplink pre-equalization factors for one or more resource elements associated with one or more model parameters associated with the local AI/ML model based on, for example, the uplink scaling factor. The WTRU may determine the one or more uplink pre-equalization factors based on the calibration response message. The WTRU may determine the one or more uplink pre-equalization factors based on the received training related information (e.g., as described herein). The WTRU may update the local AI/ML model in each training round of a plurality of OTA-FL training rounds based on, for example, the determined one or more uplink pre-equalization factors.

The WTRU (and/or a WTRU group) may transmit the pre-equalized locally updated AI/ML model parameters (and/or the pre-equalized gradients and/or the pre-equalized AI/ML model parameter incremental updates) through the UL resources allocated for OTA-FL model parameter exchange. For example, the WTRU may send (e.g., to the network, via the transceiver), one or more pre-equalized model parameters using the one or more associated resource elements of the local AI/ML model. The WTRU may use the one or more allocations of uplink resources (e.g., as described herein) to send the one or more pre-equalized model parameters. A plurality of WTRUs may include the WTRU. The WTRU may send the one or more pre-equalized model parameters using the same one or more allocations of uplink resources as allocated to at least one other WTRU of the plurality of WTRUs that are performing the same OTA-FL training task and/or a similar OTA-FL training task.

Embodiments described herein may include one or more procedures from the NW-side.

A NW may identify one or more WTRUs requesting FL-based training of the AI/ML model for the same (and/or similar) function.

The NW may identify a common AI/ML model architecture. For example, one or more WTRUs may train AI/ML models for similar classification functions, where the one or more WTRUs have different subset(s) of classes. It may lead to a common neural network architecture in the first set of layers, while the last few layers may be specialized for each WTRU corresponding to their class(es).

The NW may create one or more WTRU groups, for example, based on WTRU computed capabilities.

The NW may select one of the WTRUs to provide its AI/ML model to the NW.

The NW may select one of the provided AI/ML model(s) and/or may select another AI/ML model to be used as the (e.g., pre-trained) first AI/ML model for the one or more (e.g., multiple) WTRUs (e.g., WTRU group) participating in the same OTA-FL training task.

The NW may transmit the (e.g., pre-trained) first AI/ML model for the one or more (e.g., multiple) WTRUs (e.g., WTRU group) participating in the same OTA-FL training task.

The NW may receive an AI/ML model update feedback message from the WTRU and/or from the WTRU group). The NW may use the received AI/ML model update feedback message to determine whether the WTRU is qualified and/or partially qualified and/or disqualified for participating in one or more OTA-FL training rounds.

The NW may receive local AI/ML model training data information (e.g., size, quality, diversity, etc.) from the WTRU and/or the WTRU group.

The NW may transmit a training data configuration message to the WTRU (and/or to the WTRU group). The training data configuration message may include information about how to select the training data to train a third (e.g., local) AI/ML model.

The NW may receive a calibration transmission from the WTRU and/or the WTRU group. The NW may determine whether the WTRU is qualified and/or partially qualified and/or disqualified for participating in one or more OTA-FL training rounds based on the received calibration transmission.

The NW may send a calibration message to the WTRU and/or the WTRU group. The calibration message may include the (e.g., measured) DL/UL channels amplitude error and/or phase error by the NW. The calibration message may provide feedback on the (e.g., measured) analog and/or digital error(s) per RE, per OFDM symbol, per subcarrier per RB set, and/or per resource block groups (RBGs).

The NW may configure the WTRU and/or the WTRU group to participate in one or more OTA-FL training round(s).

The NW May receive the training statistic(s) (e.g., as described herein) from each WTRU (e.g., of the WTRU group).

The NW may receive the channel and/or transmit power related metrics from each WTRU, for example, to determine an UL scaling factor.

The NW may determine an AI/ML reporting configuration (e.g., UL scaling factor) for each WTRU based on one or more of the received AI/ML model update feedback message(s), local training data information, training statistics, DL channel estimate statistics, and/or WTRU power headroom report for OTA-FL from WTRUs participating in OTA-FL training rounds.

The NW may transmit the AI/ML reporting configuration (e.g., UL scaling factor) to each WTRU.

The WTRU may receive the OTA aggregated locally updated second AI/ML model parameter(s) (and/or gradients, and/or the AI/ML model incremental update(s)) form the WTRUs in OTA-FL manner.

In OTA-FL, each participating WTRU may locally train an AI/ML model for the same (and/or similar) task. When a WTRU is configured to pre-equalize the transmission of (partially) trained local AI/ML model parameter(s), the pre-equalization may target improving the quality of OTA aggregation, for example, through preventing pathloss biased OTA aggregation and/or enabling weighted OTA aggregation. The pre-equalization may target mitigating the effect of wireless channels. The pre-equalization performance may be based on uplink channel estimation accuracy. The pre-equalization may require determining and/or configuring an uplink scaling factor for each WTRU participating to the OTA-FL training rounds. As shown in Equation three, the UL scaling factor may enable weighted OTA aggregation. An (e.g., optimal) uplink scaling factor may be based on one or more (e.g., various) parameters including the local data information (e.g., size, quality, and/or diversity of local data), the locally updated (e.g., trained) AI/ML model performance, the channel estimate statistic(s) (e.g., maximum/minimum/mean channel power, pathloss, etc.), and/or the like. Embodiments described herein may include WTRU procedures to support determining the uplink scaling factor in OTA-FL training rounds. Embodiments herein may be applicable for time division duplexing (TDD) and/or frequency division duplexing (FDD) wireless communication systems.

The NW may initiate the WTRU capability exchange process, for example, by sending the UECapabilityEnquiry radio resource control (RRC) message to the WTRU. This message may be used to request specific information regarding one or more capabilities of the WTRU. The NW may include parameter(s) in this message to specify which capabilities the NW is interested in. The NW may specify parameter(s) related to the capability of the WTRU in supporting OTA-FL training in the UECapabilityEnquiry message (e.g., the capability of transmitting AI/ML model parameter(s), reporting local training data information, reporting training statistics, reporting the DL channel statistics). Additionally or alternatively, a WTRU may initiate the capability exchange process (e.g., as described herein).

Upon receiving the UECapabilityEnquiry RRC message, the WTRU may respond with the UECapabilityInformation RRC message, accordingly. This message may include detailed information about the WTRU's capability in supporting OTA-FL training rounds. The WTRU may indicate (e.g., in the UECapabilityInformation RRC message) one or more of the following parameters. The WTRU may indicate (e.g., in the UECapabiltyInformation RRC message) whether the WTRU supports or does not support OTA-FL. The WTRU may indicate (e.g., in the UECapabilityInformation RRC message) whether the WTRU supports or does not support receiving a pre-trained first AI/ML model from the NW. The WTRU may indicate (e.g., in the UECapabilityInformation RRC message) whether the WTRU supports or does not support receiving a part of a pre-trained first AI/ML model from the NW. The WTRU may indicate (e.g., in the UECapabilityInformation RRC message) whether the WTRU supports or does not support sending an AI/ML model update feedback message to the NW is supported or not may be included. The WTRU may indicate (e.g., in the UECapabilityInformation RRC message) whether the WTRU supports or does not support reporting the local training data information (e.g., size, quality, diversity of local data) to the NW. The WTRU may indicate (e.g., in the UECapabilityInformation RRC message) whether the WTRU supports or does not support sending a calibration transmission (e.g., SRS) to the NW. The WTRU may indicate (e.g., in the UECapabilityInformation RRC message) whether the WTRU supports or does not support receiving a calibration message from the NW. The WTRU may indicate (e.g., in the UECapabilityInformation RRC message) whether the WTRU supports or does not support correcting the phase error between UL channel and DL channel (e.g., through the received calibration message). The WTRU may indicate (e.g., in the UECapabilityInformation RRC message) whether the WTRU supports or does not support correcting the amplitude error between UL channel and DL channel (e.g., through the received calibration message). The WTRU may indicate (e.g., in the UECapabilityInformation RRC message) whether the WTRU supports or does not support training of the pre-trained first AI/ML model. The WTRU may indicate (e.g., in the UECapabilityInformation RRC message) whether the WTRU supports or does not support training a portion of the pre-trained first AI/ML model (e.g., only last few layers). The WTRU may indicate (e.g., in the UECapabilityInformation RRC message) whether the WTRU supports or does not support sending the locally updated AI/ML model parameter(s) to the NW. The WTRU may indicate (e.g., in the UECapabilityInformation RRC message) whether the WTRU supports or does not support sending the gradient(s) to the NW. The WTRU may indicate (e.g., in the UECapabilityInformation RRC message) whether the WTRU supports or does not support sending, to the NW, the AI/ML model parameter incremental update(s) (e.g., the difference between the parameters of the locally updated AI/ML model and a reference AI/ML model). The reference AI/ML model may be the most recently received AI/ML model from the NW, for example, as a result of aggregation, or the AI/ML model may be the initial AI/ML model configured by the NW. The WTRU may indicate (e.g., in the UECapability Information RRC message) whether the WTRU supports or does not support reporting training statistics to the NW. The WTRU may indicate (e.g., in the UECapabilityInformation RRC message) whether the WTRU supports or does not support performing the DL channel estimate statistic(s) to the NW. The WTRU may indicate (e.g., in the UECapabilityInformation RRC message) whether the WTRU supports or does not support reporting WTRU power headroom for OTA-FL to the NW. The WTRU may indicate (e.g., in the UECapabilityInformation RRC message) whether the WTRU supports or does not support receiving the UL scaling facto from the NW. The WTRU may indicate (e.g., in the UECapabilityInformation RRC message) whether the WTRU supports or does not support using a denoising filter (e.g., Gaussian filter, median filter, bilateral filter) for improving DL channel estimation accuracy. The WTRU may indicate (e.g., in the UECapabilityInformation RRC message) whether the WTRU supports or does not support performing UL pre-equalization (e.g., phase correction, channel inversion, truncated channel inversion). The WTRU may indicate (e.g., in the UECapabilityInformation RRC message) whether the WTRU supports or does not support applying the pre-equalization to the locally updated AI/ML model parameter(s) by using one or more of the estimated DL channels, the received calibration message, and/or the UL scaling factor. The WTRU may indicate (e.g., in the UECapabilityInformation RRC message) whether the WTRU supports or does not support applying the pre-equalization to the gradients by using one or more of the estimated DL channels, the received calibration message, and/or the UL scaling factor. The WTRU may indicate (e.g., in the UECapabilityInformation RRC message) whether the WTRU supports or does not support applying the pre-equalization to the AI/ML model parameter incremental update(s) by using one or more of the estimated DL channels, the received calibration message, and/or the UL scaling factor. The WTRU may indicate (e.g., in the UECapabilityInformation RRC message) whether the WTRU supports or does not support transmitting the pre-equalized locally updated AI/ML model parameter(s). The WTRU may indicate (e.g., in the UECapabilityInformation RRC message) whether the WTRU supports or does not support transmitting the pre-equalized gradients. The WTRU may indicate (e.g., in the UECapabilityInformation RRC message) whether the WTRU supports or does not support transmitting the pre-equalized AI/ML model parameter incremental update(s).

Through the WTRU capability exchange process (e.g., as described herein), the NW may know the capability(ies) of the WTRU to support determining the UL scaling factor in OTA-FL training rounds. For a WTRU that is capable of supporting such a function/feature (e.g., participating in OTA-FL training rounds), one or more of the following parameters may be configured by the NW. The NW may configure the WTRU to send one or more of the following parameters during OTA-FL training rounds: the locally updated AI/ML model parameter(s); the gradient(s); and/or the AI/ML model parameter incremental update(s).

The NW may send configuration information to the WTRU with respect to one or more UL resource allocations for OTA-FL training rounds to transmit the pre-equalized locally AI/ML model parameter(s) and/or the pre-equalized gradient(s), and/or the pre-equalized AI/ML model parameter incremental update(s).

The NW may send configuration information to the WTRU with respect to how to map the locally updated AI/ML model parameter(s) (and/or the gradients and/or the AI/ML model parameter incremental update(s)) to the UL resources. FIG. 6 presents an example with N real-valued AI/ML parameters transmitted without (e.g., any) encoding and/or digital modulation to achieve over-the-air aggregation, where each of two AI/ML model parameters may be combined as the real-part and imaginary-part of a complex symbol. The corresponding complex symbol may be mapped to an uplink RE. In examples, N/2 uplink REs may be required to accommodate the transmission of N real-valued AI/ML parameter(s) in the OTA-FL manner. In examples, each real-valued AI/ML model parameter may be mapped to β∈ [symbol] ⁺ uplink REs to enhance the OTA aggregation accuracy (e.g., for β=2, an AI/ML model parameter may be mapped to two uplink REs). The sign of symbols in uplink REs may be alternated to (e.g., further) reduce the phase errors (e.g., for β=2, an AI/ML model parameter may be multiplied with +1 and/or −1 to create symbols to be mapped into two uplink REs). In examples, BN uplink REs may be required to accommodate the transmission of N real-valued AI/ML parameters in the OTA-FL manner.

The NW may send configuration information to the WTRU with respect to the WTRU sending a AI/ML model update feedback message. For example, the configuration information may regard feedback periodicity (e.g., periodic, semi-persistent, and/or aperiodic).

The NW may send configuration information to the WTRU for reporting the local training data information (e.g., size, quality, diversity of local data).

The NW may send configuration information to the WTRU for reporting the training statistics. The NW may send configuration information to the WTRU for reporting the DL channel estimate statistics. The NW may send configuration information to the WTRU for reporting the WTRU power headroom for OTA-FL. The NW may send configuration information to the WTRU for receiving the UL scaling factor. The NW may send configuration information to the WTRU with respect to how to perform the UL pre-equalization (e.g., phase correction, channel inversion, truncated channel inversion).

The NW may send configuration information to the WTRU that includes training related information. The training related information may include one or more of the following. The training related information may include the learning algorithm(s), the learning rate(s), regularization parameters, etc. The training related information may include a total number of training iterations in each OTA-FL training round. The training related information may include a loss function (e.g., binary cross entropy, mean square error). The training related information may include one or more thresholds to monitor the AI/ML model training progress. The training related information may include an indicator to identify which portion(s) of the AI/ML model is trained and/or updated through OTA-FL training rounds (e.g., only last few layers are trained).

One or more of the following signalings may be referenced to enable a WTRU (and/or a WTRU group) to participate in OTA-FL training rounds and/or to determine the uplink scaling factor in OTA-FL training rounds. A signaling may include a pre-trained (e.g., global) first AI/ML model transmitted from the NW to a WTRU (and/or a WTRU group). A signaling may include a portion of a pre-trained first AI/ML model transmitted from the NW to the WTRU (and/or a WTRU group). A signaling may include a request to send a calibration transmission transmitted from the NW to the WTRU (and/or WTRU group). A signaling may include an AI/ML model update feedback message transmitted from the WTRU to the NW. A signaling may include a calibration transmission transmitted from the WTRU to the NW. A signaling may include a calibration message transmitted from the NW to the WTRU. A signaling may include a local training data information message (e.g., size, quality, diversity of local data) transmitted from the WTRU to the NW. A signaling may include configuration for participating in OTA-FL training rounds, where the configuration is transmitted from the NW to the WTRU. A signaling may include an indication to identify which portions of the AI/ML model may be trained and/or updated during OTA-FL training rounds transmitted from the NW to the WTRU. A signaling may include configuration for uplink resource allocation(s) for OTA-FL transmitted from the NW to the WTRU. A signaling may include an indication instructing the WTRU to transmit the locally updated third AI/ML model parameter(s) transmitted from the NW to the WTRU. A signaling may include configuration about how the locally updated third AI/ML model parameter(s) are mapped to uplink resources transmitted from the NW to the WTRU. A signaling may include an indication instructing the WTRU to transmit the gradient(s) transmitted from the NW to the WTRU. A signaling may include configuration about how the gradient(s) are mapped to UL resources transmitted from the NW to the WTRU. A signaling may include an indication instructing the WTRU to transmit the AI/ML model parameter incremental update(s) transmitted from the NW to the WTRU. A signaling may include configuration about how the AI/ML model parameter incremental update(s) are mapped to UL resources transmitted from the NW to the WTRU. A signaling may include a training complete message transmitted from the WTRU to the NW. A signaling may include the training statistics message transmitted from the WTRU to the NW. A signaling may include the downlink channel estimate statistics message transmitted from the WTRU to the NW. A signaling may include a WTRU power headroom report for OTA-FL transmitted form the WTRU to the NW. A signaling may include an uplink scaling factor transmitted from the NW to the WTRU. A signaling may include pre-equalized locally updated third AI/ML model parameters transmitted from the WTRU to the NW through the UL resource allocations for OTA-FL. A signaling may include pre-equalized gradients transmitted from the WTRU to the NW through the UL resource allocations for OTA-FL. A signaling may include pre-equalized AI/ML model parameter incremental update(s) transmitted from the WTRU to the NW through the UL resource allocated for OTA-FL.

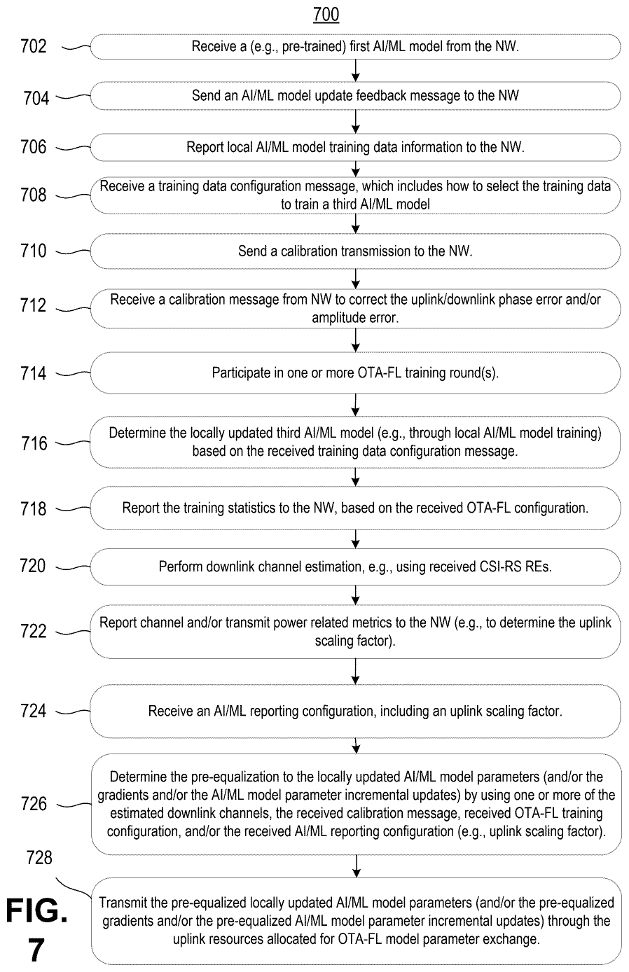

FIG. 7 depicts an example flowchart of WTRU procedures for determining an uplink scaling factor in OTA-FL training rounds. A WTRU may be configured to support determining an uplink scaling factor in OTA-FL training rounds. For example, a WTRU may receive (e.g., via a transceiver), OTA-FL configuration information associated with a local AI/ML model at the WTRU. The OTA-FL configuration information may include one or more allocations of uplink resources for one or more OTA-FL training rounds. A WTRU may send an indication to the network. The indication may indicate one or more capabilities of the WTRU to participate in one or more OTA-FL training rounds. The WTRU may receive the OTA-FL configuration information in response to the indication.

At 702, a WTRU may receive a (e.g., pre-trained) first AI/ML model and/or a portion of the first AI/ML model, for example, form a network. The pre-trained (e.g., global) first AI/ML model may be a common neural network architecture to perform the same (and/or similar) function.

At 704, a WTRU may send (e.g., through uplink control information (UCI) and/or medium access control (MAC) control element (CE) an AI/ML model update feedback message to the NW. The AI/ML model update feedback message may include one or more of the following. The AI/ML model update feedback message may include a sum (and/or mean) of difference between the received pre-trained first AI/ML model parameter(s) and a second local AI/ML model parameter(s). For example, the second local AI/ML model may be an AI/ML model trained previously (e.g., in a previous OTA-FL training round). The AI/ML model update feedback message may include the performance improvement with the received pre-trained first AI/ML model (e.g., the test performance difference between the received pre-trained first AI/ML model parameter(s) and a second local AI/ML model parameters). For example, the WTRU may send (e.g., via the transceiver) feedback information to a network. The feedback information may include one or more of local training data information, an indication of the performance of the local AI/ML model, one or more channel estimates, and/or one or more transmit power related metrics.

At 706, the WTRU may report local AI/ML model training data information (e.g., size, quality, diversity, etc.) to the NW.

At 708, the WTRU may receive a training data configuration message. The training data configuration may include information with respect to how to select the training data to train a third (e.g., local) AI/ML model. For example, in a classification problem, the WTRU may locally train the entire (or part of) AI/ML model by using (e.g., only) the selected data classes, which may be configured through the data configuration message. The NW may select the corresponding data classes, which the AI/ML model may achieve poor performance. For example, the network may select the parts of the AI/ML model to be updated by the WTRU. Such selection may be based on performance of those parts below a threshold. Triggers for such event may include one or more of: fine-tuning the AI/ML model caused by model drift; one or more other candidate layers; and/or fine-tuning for a similar task (e.g., transfer learning, etc.).

At 710, the WTRU may send a calibration transmission (e.g., sounding reference signal (SRS)) to the NW, for example, after receiving one or more downlink reference signals (e.g., phase tracking reference signal (PT-RS), channel state information reference signal (CSI-RS), etc.). The calibration transmission may include a multi-symbol response in the symbols, which may be (e.g., later) utilized for the uplink transmission(s) in the OTA-FL training rounds. The calibration transmission may be periodic, semi-persistent, aperiodic.

At 712, the WTRU may receive a calibration message from the NW, for example, to correct the UL/DL phase error and/or amplitude error. The calibration message may indicate how the WTRU adjusts the phase and/or amplitude (e.g., per resource element (RE)). The calibration message may include one or more parameters for enabling a WTRU to perform the prediction(s) on the channel aging and/or the predictions for pre-equalization. The calibration message may indicate which set of REs are qualified for the UL transmission in OTA-FL training rounds (e.g., first two OFDM symbols after CSI-RS are qualified, while next OFDM symbols are disqualified).

At 714, the WTRU and/or a WTRU group may be configured to participate in one or more OTA-FL training round(s). The WTRU may receive a request and/or an indication to participate in one or more OTA-FL training rounds for updating the model parameter(s) of the received pre-trained first AI/ML model and/or the locally trained second AI/ML model. The WTRU may receive an indication to identify which portion(s) of the AI/ML model may be trained and/or updated through OTA-FL training round(s) (e.g., only last few layers may be trained). The WTRU may receive configuration to send one or more of the following parameters. The WTRU may receive configuration to send the locally updated third AI/ML model parameter(s) for the AI/ML model being locally trained (e.g., weights and/or biases). The WTRU may receive configuration to send the AI/ML model parameter incremental update(s) (e.g., the difference between the parameters of the locally updated third AI/ML model and a reference AI/ML model). The reference AI/ML model may be a most recently received AI/ML model from the NW (e.g., as result of aggregation, and/or the initial AI/ML model configured by the NW). The WTRU may receive configuration to send the gradient (and/or a set of gradients, and/or a function of the gradient(s)) of the loss function with respect to the AI/ML model parameter(s) measured by the WTRU during local training and/or loss computation(s). In examples, the optimizer function may be in the NW. The WTRU may receive uplink resource allocation(s) for OTA-FL training round(s), which may be common for one or more (e.g., all) WTRUs participating in the same one or more OTA-FL training round(s). For example, the one or more WTRUs participating in the same one or more OTA-FL training round(s) may use one or more of the same UL resources to transmit the locally updated third AI/ML model parameter(s) and/or the gradient(s) and/or the AI/ML model parameter incremental update(s).

The WTRU may receive a configuration about how the locally updated third AI/ML model parameter(s) (and/or the gradients and/or the AI/ML model parameter incremental update(s)) are mapped to UL resources. FIG. 6 depicts an example of mapping the locally updated (e.g., trained) artificial intelligence (AI)/machine learning (ML) model parameters to the uplink resources during OTA-FL transmissions. FIG. 6 presents an example with N real-valued AI/ML parameters transmitted without (e.g., any) encoding and/or digital modulation to achieve over-the-air aggregation, where each of two AI/ML model parameters may be combined as the real-part and imaginary-part of a complex symbol. The corresponding complex symbol may be mapped to an uplink RE. In examples, N/2 uplink REs may be required to accommodate the transmission of N real-valued AI/ML parameter(s) in the OTA-FL manner. In examples, each real-valued AI/ML model parameter may be mapped to β∈ [symbol] ⁺ uplink REs to enhance the OTA aggregation accuracy (e.g., for β=2, an AI/ML model parameter may be mapped to two uplink REs). The sign of symbols in uplink REs may be alternated to (e.g., further) reduce the phase errors (e.g., for β=2, an AI/ML model parameter may be multiplied with +1 and/or −1 to create symbols to be mapped into two uplink REs). In examples, BN uplink REs may be required to accommodate the transmission of N real-valued AI/ML parameters in the OTA-FL manner.

To participate in the one or more OTA-FL training rounds, the WTRU may receive a configuration for what type of uplink pre-equalization (e.g., phase correction, channel inversion, truncated channel inversion) may be included. The WTRU may apply one or more of a phase correction, a channel inversion, and/or a truncated channel inversion based on the one or more uplink pre-equalization factors. The WTRU being configured to determine the one or more uplink pre-equalization factors may include the WTRU being configured to use the uplink scaling factor to compensate for one or more of the phase correction, the channel inversion, and/or the truncated channel inversion.

To participate in the one or more OTA-FL training rounds, the WTRU may receive training related information (e.g., loss function, epoch, learning rate, a set of thresholds to monitor the training progress, etc.). For example, the WTRU may receive training related information; the training related information may include one or more of a loss function, an epoch, a learning rate, and/or a set of thresholds to monitor training progress of the local AI/ML model.

At 716, the WTRU may determine the locally updated third AI/ML model (e.g., through local AI/ML model training), for example, based on the received training data configuration message. The WTRU may train the (e.g., entire, portion of) AI/ML model based on the received configuration. The WTRU may perform fine-tuning to the received pre-trained first AI/ML model. The WTRU may send a message indicating that the locally updated second AI/ML model has been (e.g., sufficiently) trained to the NW, for example, when the WTRU detects that the training is sufficient through evaluating the performance of the locally updated second AI/ML model based on the configured thresholds for performance monitoring. One or more factors and/or training-stop rules may be included to determine whether training is sufficient. For example, the WTRU can determine sufficient training in FL by monitoring local model performance, resource constraint(s), gradient update(s), and/or feedback from the FL server on global model convergence, etc.

At 718, the WTRU may report the training statistic(s) to the NW, for example, based on the received OTA-FL configuration. The training statistic(s) may include one or more of the locally updated third AI/ML model parameter information (e.g., maximum, minimum, mean, variance of the locally updated AI/ML model parameter(s) and/or the gradient(s) and/or the AI/ML model parameter incremental update, etc.).

At 720, the WTRU may perform DL channel estimation, for example, by using received CSI-RS RES.

At 722, the WTRU may report channel and/or transmit power related metric(s) to the NW to determine an uplink scaling factor. The reported metric(s) may include one or more of downlink channel estimate statistics (e.g., maximum, minimum, mean, variance of DL channel estimates, the estimated DL channel path loss) and/or the WTRU transmit power headroom report (PHR) for OTA-FL transmission, which may refer to WTRU Max transmission power minus P (OTA-FL). The parameter P (OTA-FL) may be the estimated transmit power of the scheduled OTA-FL transmission in the unweighted manner. For example, the one or more channel estimates may include one or more of a maximum channel power, a minimum channel power, a mean channel power, and/or a pathloss. For example, the one or more transmit power related metrics may include a WTRU transmit power headroom report (PHR) for OTA-FL transmission.

At 724, the WTRU may receive an AI/ML reporting configuration, including the uplink scaling factor. For example, the WTRU may receive (e.g., from the network, via the transceiver) model reporting configuration. The model parameter reporting configuration may include an uplink scaling factor.

At 726, the WTRU may determine the pre-equalization to the locally updated AI/ML model parameter(s) (and/or the gradients and/or the AI/ML model parameter incremental updates) by using one or more of the estimated DL channels, the received calibration message, received OTA-FL training configuration, and/or the received AI/ML reporting configuration (e.g., UL scaling factor). For example, the WTRU may determine one or more uplink pre-equalization factors for one or more resource elements associated with one or more model parameters associated with the local AI/ML model based on, for example, the uplink scaling factor. The WTRU may determine the one or more uplink pre-equalization factors based on the calibration response message. The WTRU may determine the one or more uplink pre-equalization factors based on the received training related information (e.g., as described herein). The WTRU may update the local AI/ML model in each training round of a plurality of OTA-FL training rounds based on, for example, the determined one or more uplink pre-equalization factors. The one or more pre-equalized model parameters may include one or more of: one or more weights and/or biases associated with the local AI/ML model; one or more AI/ML model parameter incremental updates based on a difference between one or more parameters of the local AI/ML model and one or more parameters of a second AI/ML model sent from the network; and/or a gradient of a loss function associated with the one or more parameters of the local AI/ML model.

At 728, the WTRU (and/or a WTRU group) may transmit the pre-equalized locally updated AI/ML model parameters (and/or the pre-equalized gradients and/or the pre-equalized AI/ML model parameter incremental updates) through the UL resources allocated for OTA-FL model parameter exchange. For example, the WTRU may send (e.g., to the network, via the transceiver), one or more pre-equalized model parameters using the one or more associated resource elements of the local AI/ML model. The WTRU may use the one or more allocations of uplink resources (e.g., as described herein) to send the one or more pre-equalized model parameters. A plurality of WTRUs may include the WTRU. The WTRU may send the one or more pre-equalized model parameters using the same one or more allocations of uplink resources as allocated to at least one other WTRU of the plurality of WTRUs that are performing the same OTA-FL training task and/or a similar OTA-FL training task.

Embodiments described herein may include one or more procedures from the NW-side.

A NW may identify one or more WTRUs requesting FL-based training of the AI/ML model for the same (and/or similar) function.

The NW may identify a common AI/ML model architecture. For example, one or more WTRUs may train AI/ML models for similar classification functions, where the one or more WTRUs have different subset(s) of classes. It may lead to a common neural network architecture in the first set of layers, while the last few layers may be specialized for each WTRU corresponding to their class(es).

The NW may create one or more WTRU groups, for example, based on WTRU computed capabilities.

The NW may select one of the WTRUs to provide its AI/ML model to the NW.

The NW may select one of the provided AI/ML model(s) and/or may select another AI/ML model to be used as the (e.g., pre-trained) first AI/ML model for the one or more (e.g., multiple) WTRUs (e.g., WTRU group) participating in the same OTA-FL training task.

The NW may transmit the (e.g., pre-trained) first AI/ML model for the one or more (e.g., multiple) WTRUs (e.g., WTRU group) participating in the same OTA-FL training task.

The NW may receive an AI/ML model update feedback message from the WTRU and/or from the WTRU group). The NW may use the received AI/ML model update feedback message to determine whether the WTRU is qualified and/or partially qualified and/or disqualified for participating in one or more OTA-FL training rounds.

The NW may receive local AI/ML model training data information (e.g., size, quality, diversity, etc.) from the WTRU and/or the WTRU group.

The NW may transmit a training data configuration message to the WTRU (and/or to the WTRU group). The training data configuration message may include information about how to select the training data to train a third (e.g., local) AI/ML model.

The NW may receive a calibration transmission from the WTRU and/or the WTRU group. The NW may determine whether the WTRU is qualified and/or partially qualified and/or disqualified for participating in one or more OTA-FL training rounds based on the received calibration transmission.

The NW may send a calibration message to the WTRU and/or the WTRU group. The calibration message may include the (e.g., measured) DL/UL channels amplitude error and/or phase error by the NW. The calibration message may provide feedback on the (e.g., measured) analog and/or digital error(s) per RE, per OFDM symbol, per subcarrier per RB set, and/or per resource block groups (RBGs).

The NW may configure the WTRU and/or the WTRU group to participate in one or more OTA-FL training round(s).

The NW May receive the training statistic(s) (e.g., as described herein) from each WTRU (e.g., of the WTRU group).

The NW may receive the channel and/or transmit power related metrics from each WTRU, for example, to determine an UL scaling factor.

The NW may determine an AI/ML reporting configuration (e.g., UL scaling factor) for each WTRU based on one or more of the received AI/ML model update feedback message(s), local training data information, training statistics, DL channel estimate statistics, and/or WTRU power headroom report for OTA-FL from WTRUs participating in OTA-FL training rounds.

The NW may transmit the AI/ML reporting configuration (e.g., UL scaling factor) to each WTRU.

Numerical results may be presented with respect to determining and configuring the UL scaling factor in OTA-FL training rounds. The simulations were performed by using Sionna, which is an open-source Python library for the link-level simulations based on TensorFlow. The simulation included the use case of image classification with well-known CIFAR-10 dataset, which includes 10 data classes (e.g., airplane, automobile, bird, car, deer, dog, frog, horse, ship and truck). The CIFAR-10 dataset includes 50,000 training and 10,000 test images.

The simulation parameters are summarized in Table 1. The simulation(s) include 6 WTRUs participating in OTA-FL training rounds. A part of training dataset may be split between the WTRUs. Specifically, the first WTRU (WTRU1) may have larger dataset size compared to one or more (e.g., all) others, while the remaining WTRUs (WTRU2, WTRU3, WTRU4, WTRU5, WTRU6) have the same dataset size. Configuring a particular uplink scaling factor for each WTRU may enable weighted OTA aggregation. Embodiments herein may enable setting a higher uplink scaling factor for WTRU1 compared to other WTRUs since WTRU1 may have larger dataset size.

The weighted OTA aggregation (e.g., weighted averaging of locally updated, for example, trained AI/ML model parameters) at t^{th} OTA-FL training round may be expressed as follows:

$${w}_{Global}^{( t )} = \frac{1}{{α}_{1} + {α}_{2} + ⋯ + {α}_{6}} {\sum }_{k = 1}^{6} {α}_{k} {w}_{k}^{( t )}$$

where αₖ may denote the weight for the k^{th} WTRU,

$${w}_{k}^{( t )}$$

may denote the locally updated AI/ML model parameters at the k^{th} WTRU at t^{th} OTA-FL. For the unweighted OTA aggregations, one or more (e.g., all) weights may be equal to each other (e.g., α₁= . . . =α₆) with

$${w}_{Global}^{( t )} = \frac{1}{6} {\sum }_{k = 1}^{6} {w}_{k}^{( t )} .$$

For the weighted OTA aggregation, α₁ may be varied through the configured uplink scaling factor, while keeping α₂=α₃=α₄=α₅=α₆=1.

TABLE 1
Simulation Results

| Number of gNB | 1 | |
|---|---|---|
| Number of UEs | 6 | |
| Number of Antenna at gNB | 1 | |
| Number of Antenna at UE | 1 | |
| Channel Model | UMi | |
| Channel Normalization | True | |
| Subcarrier Spacing | 30 | kHz |
| Number of RBs | 24 | |
| Number of subcarriers | 288 | |
| Bandwidth | 10 | MHz |

Table 2 presents the parameters related to the AI/ML model training through OTA-FL. The test dataset may be considered as the global test dataset at the NW, while the training datasets are located at the corresponding WTRUs for local AI/ML model training. After the local AI/ML model trainings, for example, the NW may receive the (e.g., weighted, unweighted) OTA aggregated AI/ML model parameter update(s) for obtaining a global AI/ML model. The NW may test its performance through the global test dataset. Additionally or alternatively, three scenarios for training dataset split between 6 WTRUSs may be considered. A first scenario may include WTRU1 with 10,000 data and WTRU2-WTRU6 with 1,000 data. A second scenario may include WTRU1 with 10,000 data and WTRU2-WTRU6 with 2,000 data. A third scenario may include WTRU1 with 20,000 data and WTRU2-WTRU6 with 2,000 data.

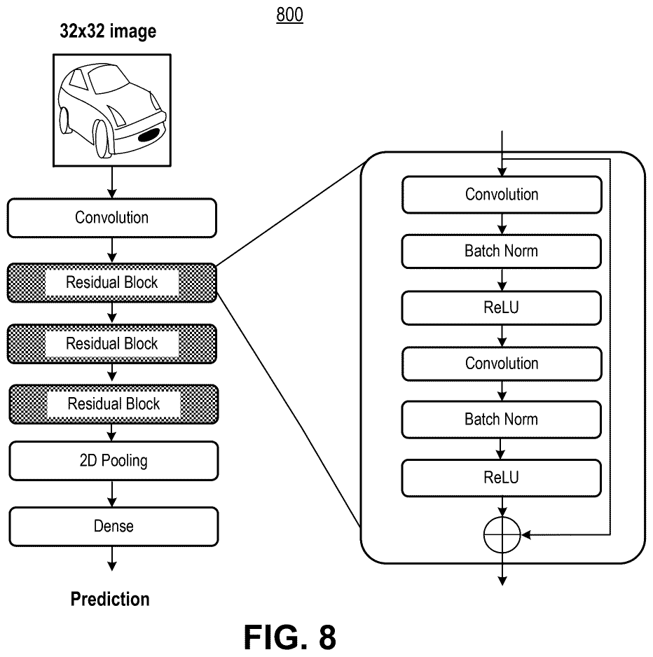

FIG. 8 depicts an example ResNet-8 model 800 that may be utilized for the AI/ML-based image classification, which has 75,770 real-valued parameters. After each WTRU performs the local AI/ML model training, for example, each of two AI/ML model parameters' updates may be combined as the real-part and imaginary-part of a complex data symbol. The corresponding complex symbol may be mapped to an uplink RE (e.g., as illustrated in FIG. 6). Since there may be 4032 uplink REs per slot (e.g., 14 OFDM symbols and 288 subcarriers) and each may carry two AI/ML model parameter updates, one OTA-FL training round may be completed in

$$⌈ \frac{75770}{2 \times 4032} ⌉ = 10 uplink slots .$$

One or more (e.g., all) 14 OFDM symbols per slot may be used for sending AI/ML model parameter updates for OTA-FL training. Additionally or alternatively, 10 OTA-FL training rounds may be performed to train a global AI/ML-based image classification, which may require 100 uplink slots in total.

TABLE 2
Parameters on Al/ML model training through OTA-FL.

| | |
|---|---|
| Dataset Size | 50,000 training data (split among |
| | WTRUs) 10,000 test data |
| Optimizer | Adam |
| Learning Rate | 0.001 |
| Batch Size | 32 |
| Local Epochs per OTA-FL | 1 |
| Training Round | |
| Model Params | 75,770 |
| Number of Uplink RE per Slot | 4032 (14 OFDM Symbols × 288 |
| | Subcarriers) |
| OTA-FL Communication Overhead | $\begin{matrix}10 Uplink Slots per OTA - FL Training \\ Round = ⌈ \frac{75770}{2 \times 4032} ⌉\end{matrix}$ |
| Number of OTA-FL Training | 10 |
| Rounds | |

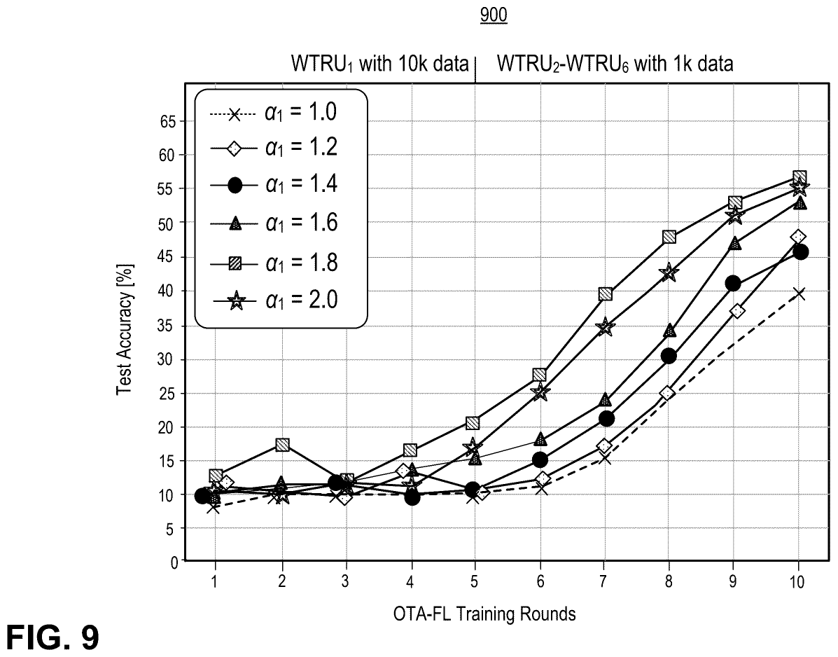

FIG. 9 depicts an image classification test accuracy during OTA-FL training rounds for Scenario #1 900. FIG. 9 presents the image classification test accuracy performance with different values of α1 during the OTA-FL training rounds for Scenario #1 (e.g., WTRU1 with 10,000 data, WTRU2-WTRU6 with 1,000 data). The numerical results may show that the best weight for WTRU1 is α₁=1.8, which can be configured though the uplink scaling factor. For example, the weighted OTA aggregation may achieve 56% accuracy at the 10th OTA-FL training round, while the baseline unweighted OTA aggregation with α₁=1.0 may (e.g., only) achieves 39% accuracy. The weighted OTA aggregation may improve the image classification accuracy with lower communication overhead.

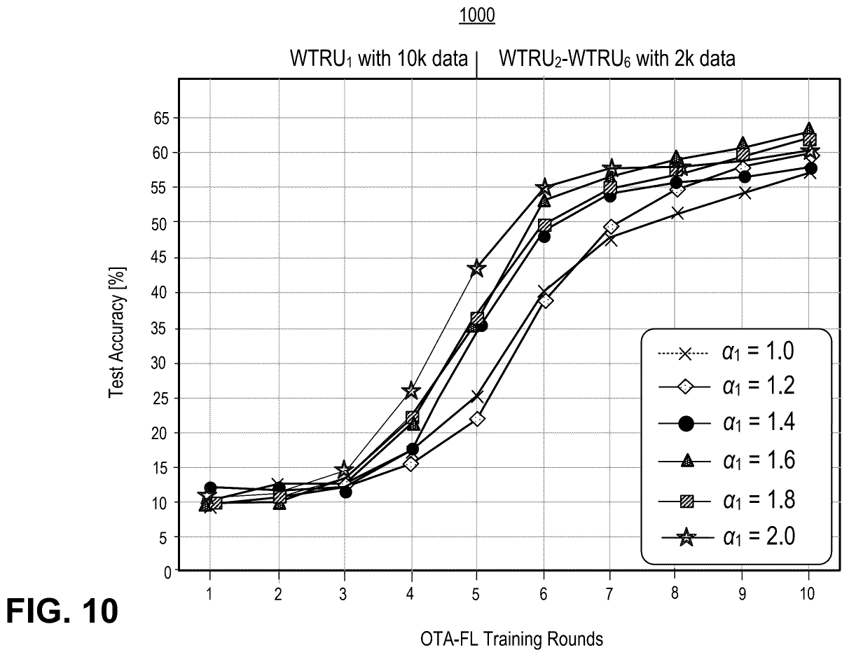

FIG. 10 depicts an image classification test accuracy during OTA-FL training rounds for Scenario #2 1000. FIG. 10 demonstrates the image classification test accuracy performance with different values of α1 during the OTA-FL training rounds for Scenario #2 (e.g., WTRU1 with 10,000 data, WTRU2-WTRU6 with 2,000 data). Although the best weight for WTRU1 is α₁=2.0 up to the 7th OTA-FL training round, later on, α₁=1.6 may become the best weight for WTRU1. This may (e.g., further) suggest the adaptive weight selection (e.g., adaptive uplink scaling factor) through the OTA-FL training rounds.

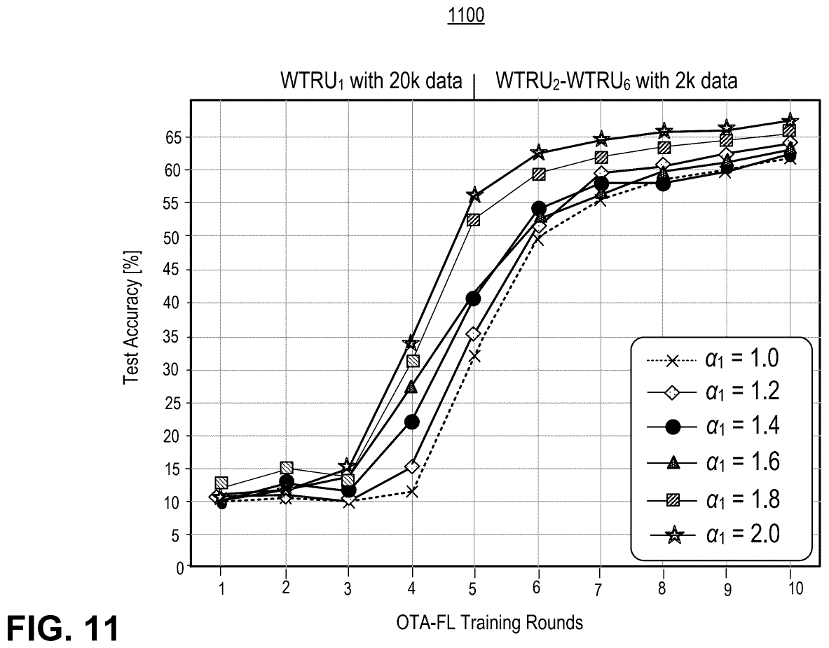

FIG. 11 depicts an image classification test accuracy during OTA-FL training rounds for Scenario #3 1100. FIG. 11 plots the image classification test accuracy performance with different values of α1 during the OTA-FL training rounds for Scenario #3 (e.g., WTRU1 with 20,000 data, WTRU2-WTRU6 with 2,000 data), where α₁=2.0 is the best weight for WTRU1. Even though the dataset size ratio between WTRU1 and one or more others may be the same for Scenario #1 and Scenario #3 (e.g., WTRU1 has 10 times larger dataset size), the best weights may be different. Therefore, the NW may target optimizing the uplink scaling factor for each WTRU by considering one or more (e.g., various) factors including the dataset information.

1. A wireless transmit/receive unit (WTRU) comprising:
a transceiver; and
a processor configured to:
receive, via the transceiver, over-the-air federated learning (OTA-FL) configuration information associated with a local artificial intelligence (AI)/machine learning (ML) model at the WTRU;
send, via the transceiver, feedback information to a network;
receive from the network, via the transceiver, model parameter reporting configuration, wherein the model parameter reporting configuration information comprises an uplink scaling factor;
determine one or more uplink pre-equalization factors for one or more resource elements associated with one or more model parameters associated with the local AI/ML model based on the uplink scaling factor; and
send to the network, via the transceiver, one or more pre-equalized model parameters using the one or more associated resource elements of the local AI/ML model.

2. The WTRU of claim 1, wherein the feedback information comprises one or more of local training data information, an indication of the performance of the local AI/ML model, one or more channel estimates, or one or more transmit power related metrics.

3. The WTRU of claim 1, wherein the processor is configured to:
send a calibration transmission to the network;
receive a calibration response message from the network; and
determine the one or more uplink pre-equalization factors based on the calibration response message.

4. The WTRU of claim 1, wherein the OTA-FL configuration information comprises one or more allocations of uplink resources for one or more OTA-FL training rounds, and wherein the processor is configured to use the one or more allocations of uplink resources to send the one or more pre-equalized model parameters.

5. The WTRU of claim 4, wherein a plurality of WTRUs comprises the WTRU, and wherein the processor is configured to send the one or more pre-equalized model parameters using the same one or more allocations of uplink resources as allocated to at least one other WTRU of the plurality of WTRUs that are performing the same OTA-FL training task or a similar OTA-FL training task.

6. The WTRU of claim 1, wherein the processor is configured to apply one or more of a phase correction, a channel inversion, or a truncated channel inversion based on the determined one or more uplink pre-equalization factors.

7. The WTRU of claim 6, wherein the processor being configured to determine the one or more uplink pre-equalization factors comprises the processor being configured to use the uplink scaling factor to compensate for one or more of the phase correction, the channel inversion, or the truncated channel inversion.

8. The WTRU of claim 1, wherein the one or more channel estimates comprise one or more of a maximum channel power, a minimum channel power, a mean channel power, or a pathloss, and wherein the one or more transmit power related metrics comprises a WTRU transmit power headroom report (PHR) for OTA-FL transmission.

9. The WTRU of claim 1, wherein the one or more pre-equalized model parameters comprise one or more of: one or more weights or biases associated with the local AI/ML model; one or more AI/ML model parameter incremental updates based on a difference between one or more parameters of the local AI/ML model and one or more parameters of a second AI/ML model sent from the network; or a gradient of a loss function associated with the one or more parameters of the local AI/ML model.

10. The WTRU of claim 1, wherein the processor is configured to receive training related information, wherein the training related information comprises one or more of a loss function, an epoch, a learning rate, or a set of thresholds to monitor training progress of the local AI/ML model, and wherein the processor is configured to determine the one or more uplink pre-equalization factors based on the received training related information.

11. The WTRU of claim 1, wherein the processor is configured to send an indication to the network, wherein the indication indicates one or more capabilities of the WTRU to participate in one or more OTA-FL training rounds, and wherein the OTA-FL configuration information is received in response to the indication.

12. The WTRU of claim 1, wherein the processor is configured to update the local AI/ML model in each training round of a plurality of OTA-FL training rounds based on the determined one or more uplink pre-equalization factors.

13. A method performed by a wireless transmit/receive unit (WTRU), the method comprising:
receiving over-the-air federated learning (OTA-FL) configuration information associated with a local artificial intelligence (AI)/machine learning (ML) model at the WTRU;
sending feedback information to a network;
receiving, from the network model parameter reporting configuration, wherein the model parameter reporting configuration information comprises an uplink scaling factor;
determining one or more uplink pre-equalization factors for one or more resource elements associated with one or more model parameters associated with the local AI/ML model based on the uplink scaling factor; and
sending, to the network, one or more pre-equalized model parameters using the one or more associated resource elements of the local AI/ML model.

14. The method of claim 13, wherein the feedback information comprises one or more of local training data information, an indication of the performance of the local AI/ML model, one or more channel estimates, or one or more transmit power related metrics.

15. The method of claim 13, further comprising:
sending a calibration transmission to the network;
receiving a calibration response message from the network; and
determining the one or more uplink pre-equalization factors based on the calibration response message.

16. The method of claim 13, wherein the OTA-FL configuration information comprises one or more allocations of uplink resources for one or more OTA-FL training rounds, and wherein the method further comprising using the one or more allocations of uplink resources to send the one or more pre-equalized model parameters.

17. The method of claim 16, wherein a plurality of WTRUs comprises the WTRU, and wherein the method further comprising sending the one or more pre-equalized model parameters using the same one or more allocations of uplink resources as allocated to at least one other WTRU of the plurality of WTRUs that are performing the same OTA-FL training task or a similar OTA-FL training task.

18. The method of claim 13, further comprising applying one or more of a phase correction, a channel inversion, or a truncated channel inversion based on the determined one or more uplink pre-equalization factors.

19. The method of claim 18, wherein determining the one or more uplink pre-equalization factors comprises using the uplink scaling factor to compensate for one or more of the phase correction, the channel inversion, or the truncated channel inversion.

20. The method of claim 13, wherein the one or more channel estimates comprise one or more of a maximum channel power, a minimum channel power, a mean channel power, or a pathloss, and wherein the one or more transmit power related metrics comprises a WTRU transmit power headroom report (PHR) for OTA-FL transmission.

21. The method of claim 13, wherein the one or more pre-equalized model parameters comprise one or more of: one or more weights or biases associated with the local AI/ML model; one or more AI/ML model parameter incremental updates based on a difference between one or more parameters of the local AI/ML model and one or more parameters of a second AI/ML model sent from the network; or a gradient of a loss function associated with the one or more parameters of the local AI/ML model.

22. The method of claim 13, further comprising receiving training related information, wherein the training related information comprises one or more of a loss function, an epoch, a learning rate, or a set of thresholds to monitor training progress of the local AI/ML model, and wherein the method further comprising determining the one or more uplink pre-equalization factors based on the received training related information.

23. The method of claim 13, further comprising sending an indication to the network, wherein the indication indicates one or more capabilities of the WTRU to participate in one or more OTA-FL training rounds, and wherein the OTA-FL configuration information is received in response to the indication.

24. The method of claim 13, further comprising updating the local AI/ML model in each training round of a plurality of OTA-FL training rounds based on the determined one or more uplink pre-equalization factors.
